(19) United States
(12) Patent Application Publication
(10) Pub. No.: US 2006/0272967 A1
(43) Pub. Date: Dec. 7, 2006

(54) Golf bag construction

(76) Inventor: Neil Colvin Bremner, Ayrshire (GB)

Correspondence Address: GIFFORD, KRASS, GROH, SPRINKLE & CITKOWSKI, P.C, PO BOX 7021, TROY, MI, 48007-7021, US

(21) Appl. No.: 10/559,859

(22) PCT Filed: Jun. 7, 2004
(86) PCT No.: PCT/GB04/02419

§ 371 Date: Jan. 23, 2006

(30) Foreign Application Priority Data
Jun. 7, 2003 (GB) 0313149.7

(51) Int. Cl. B62K 15/00; A63B 55/00; A63B 55/06; B62B 7/00

(52) U.S. Cl. 206/315.3; 280/40; 280/655.1; 206/315.6

(57) ABSTRACT

This invention relates to a golf bag (10) having a closed base (12) and a top (14) with at leastone aperture (26) therethrough so as to receive at least one shaft of a golf club, the base (12) and the top (14) being interconnected by means of at least one tubular member (28) which has its ends secured relative to the base (12) and the top (14), characterised in that the at least one tubular member (28) has a series of apertures (26) through the side walls of the tube (28).

### FIELD OF THE INVENTION

The present invention relates to golf bags and their means and method of construction.

### BACKGROUND OF THE INVENTION

A round of golf can be subject to the vagaries of weather. When it starts to rain a golf bag can become wet which can over time cause the bag's condition and structural integrity to deteriorate. The rapid drying out of golf bags can be a very troublesome task and is not easily achieved.

### SUMMARY OF THE INVENTION

The present invention provides a golfbag having a closed base and a top with at least one aperture therethrough so as to receive at least one shaft of a golf club, the base and the top being interconnected by means of at least one tubular member which has its ends secured relative to the base and the top, characterised in that the at least one tubular member has a series of apertures through the side walls of the tube.

The at least one tubular member can have a mesh construction.

The shape of the apertures can be selected from one of or a combination of one or more of the following: circular, square, rectangular, diamond shaped, rhombic, pentagonal, hexagonal, octagonal.

The at least one tubular member can be formed as a tube by a moulding process. Alternatively the at least one tubular member can be formed from an elongated piece of sheet material with the longitudinal sides of the sheet material being joined end to end;

Between the base and the top there can be provided an spine member of a predetermined rigidity. A web member can extend from the spine portion in opposite directions around the golf bag. The web member can be located adjacent both the top and the base.

A substantial proportion of the length of the at least one tubular member remains exposed when the web portion is present.

The spine member can be hollow. The spine member can also receive a handle member which can move into and out of the spine member.

The top and the base are of substantially the same shape in plan view.

The golf bag can be a composite of a first and second portion.

The first portion can have a base, and a top which is in part the same shape as the base.

The second portion can have a top and base which are similar in plan view.

The base of the second portion can fit into the base of the first portion, with the top of the second portion being of a shape which complements the shape of the top of the first portion to form a combined shape which is substantially the same as the base of the first portion.

Both the first and second portions can have at least one tubular member having a series of lateral apertures therethrough.

The golf bag can have a removable cover. The cover can made from a synthetic or natural cloth or material. The cover can be flexible or at least in part rigid or at least in part flexible or rigid.

The first and second portion of the golf bag can be held together by a removable cover.

A latch mechanism can be used to holds the tops of the first and second portion together.

The first and second portions have complementary nesting surfaces wherein the second portion can be nested within the first portion. The nesting surfaces can be provided along one side of each of the first and second portions along a substantial length thereof.

The cover can be secured to the bag via surfaces on the top and base members or adjacent thereto. The cover can be secured by means of one or more of the following: hook and loop fixing members, spigots and eyelets, zippers, buttons, press studs.

The is preferably a plurality of tubular members and respective apertures through the top.

The golfbag can include a fitment on a side thereof the fitment allowing an undercarriage to be clamped thereto, the undercarriage have two first class levers with a common fulcrum whereby the fitment is clamped by proximal ends of the levers when the distal ends are spaced from each other. The proximal ends of the levers can have wheels rotatably mounted thereto. The levers can be held in spaced relation to each other by a strut.

The strut can be of an adjustable length or of a hinged construction.

The undercarriage can be detached and collapsed by collapsing the strut.

The above features can also be included in a method of manufacturing a golf bag such as that described below:

The invention also provides a method of manufacturing a golf bag, the method comprising the steps of:
a) forming a frame having a first and second end,
b) said first end having at least one aperture therethrough to receive a shaft of a golf club,
c) said second end being formed with a ring to receive a base
d) passing at least one tube into said frame via said ring so that the at least tube will provide a passage from a respective one of said at least one apertures to said ring
e) joining a base to said ring to secure the free ends of said at least one tube

The invention also provides a frame from which to construct a golf bag, said frame including a top end having at least one aperture therethrough to receive one or more shafts of a golf club to be held in said bag, a base ring held spaced apart from said top end by a spine which extends between said top end and said base end.

The top end and said base ring can be of the same peripheral shape.

The base ring can receive a base end cap to close said ring. The base end cap can be secured to said ring by any appropriate means such as the interaction of tongues and recesses on the base and ring, rivets, adhesive, sonic welding.

Near to said top end and said base ring a web or skirt extends from said spine around the periphery of said top end and said base ring. The web or skirt can have a tapered shape or a convergent shape whereby near to said spine said web or skirt is of a greater width or height by comparison to the a location opposite said spine.

At a location opposite to said spine a strut can be used to maintain the portions of said top end and said base ring, which are opposite to the location of connection to said spine, in their spaced apart relationship. The strut can be secured to the top end and the base ring.

The frame, top end, spine and base ring can all be formed from a single integral moulding. The strut can also be formed in the single integral moulding.

### BRIEF DESCRIPTION OF THE DRAWINGS

Embodiments of the present invention will now be described, by way of example only, with reference to the accompanying drawings in which:

FIG. 1 illustrates a perspective view of a golfbag construction with a buggy or undercarriage attached;

FIG. 2 illustrates an exploded view of a bag similar to that of FIG. 1;

FIG. 3 illustrates a perspective view of a mesh tube used with the bag of FIG. 1;

FIG. 4 illustrates a part detail of the side or mesh of the tube of FIG. 3;

FIG. 5 illustrates the bag of FIG. 1 with its components assembled and cover in position for attachment to the bag sub assembly;

FIG. 6 illustrates a perspective view of modified version of the golf bag of FIG. 2 with cover removed;

FIG. 7 illustrates a cover in partial separation from the bag of FIG. 1 or 2 and a detachable bag;

FIG. 8 illustrates the golf bag with all covers and bag portions assembled;

FIG. 9 illustrates a perspective view of an undercarriage for use with the golf bag of the previous Figures;

FIG. 10 illustrates a front elevation of the undercarriage or FIG. 9 with a bag affixed thereto.

FIG. 11 shows the bag and undercarriage of FIG. 10 in a detached condition; and

FIG. 12 shows the undercarriage in completely folded condition in situ in a carry bag

### DETAILED DESCRIPTION OF THE EMBODIMENT OR EMBODIMENTS

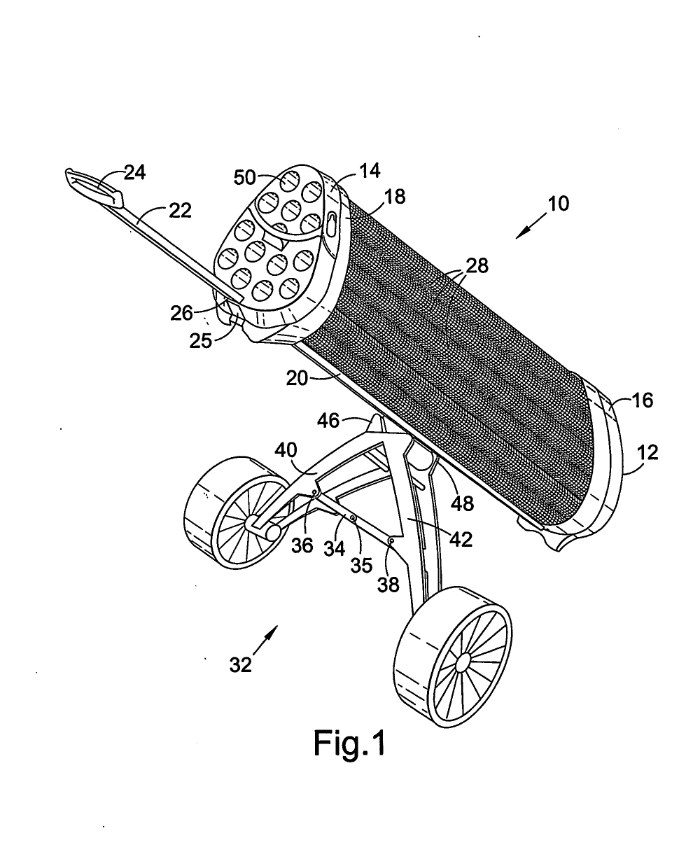

Illustrated in FIG. 1 is a golfbag 10 having a dish shaped base 12 and a like shaped top 14. The base 12 and top 14 respectively have skirts 16 and 18 which forms sides of the base 12 and top 14. The base 12 and top 14 are held in spaced apart relationship by means of a longitudinal spine 20 which engages the base 12 and top 14 at edges on the same sides thereof. This positions the spine 20 in an offset location relative to the respective centres of the base 12 and top 14.

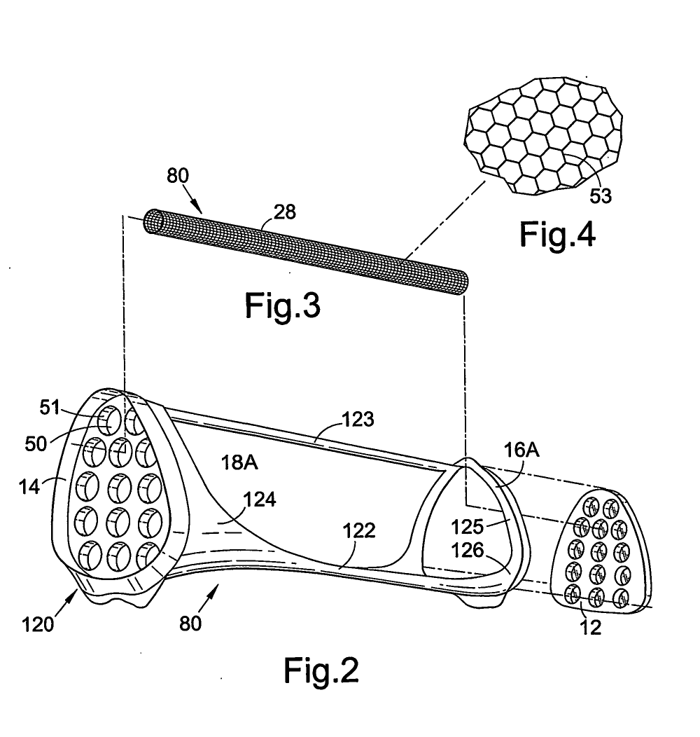

The spine 20 is constructed from an aluminium rectangular hollow section, such as that illustrated in FIG. 1, or could be made of other materials, such as steel or plastic such as that illustrated in FIG. 2. A handle support 22 is located in a telescoping manner within the spine 20, with movement into and out of the spine being allowed or prevented by means of a latch mechanism 25. The latch mechanism preferably works on a cam or friction means, but other means can be utilised. The handle support 22 terminates in a handle 24 which allows the user of the bag a grip when the bag 10 is used in conjunction with an undercarriage 32. The handle support 22 passes through an aperture 26 in the top 14.

Extending between the underside of the top 14 and the top side of the base 12 is a series of fourteen elongated tubular members 28. The ends of the tubular members 28 are secured to the base 12 and top 14. In the embodiment of FIG. 1 the tubular members 28 are preferably the same as those illustrated in FIG. 3 which have a mesh construction. However, if desired they can be solid tubular members or tubular members having continuous sides. The tubular members 28 are preferably manufactured from an appropriate plastic or polymer.

The tubular members 28 can be those illustrated in FIGS. 3 and 4 which have a series of apertures 53 through the side walls of the tubes 28. By this means a lightweight tube 28 is produced, which also allows for the flow through of air to assist in the drying out of the bag 10.

The top 14 has 14 apertures 50 therethrough, as can be seen in FIG. 1. Each aperture 50 is the terminus of an open cylindrical spigot 51 (see FIG. 2) which extends in a direction from the top 14 to the base 12. The cylindrical spigot 51 receives therein or therearound, the open end of a respective tubular member 28. The base 12 is similarly constructed, with respective cylindrical spigots on the top 14 and base 12 being aligned so that the central longitudinal axis of the tubular member 28 extends in a straight line between the top 14 and base 12.

The tubular members 28 can be riveted, glued, sonically welded or joined by any other appropriate means to the respective cylindrical spigots 51.

By means of the fourteen apertures 50 through the top 14 and fourteen tubes 28 a shaft of a golf club can be inserted through an aperture 50 then through the respective tube 28 so that the base of the club shaft can engage the base 12 thereby holding the golf club within the bag 10.

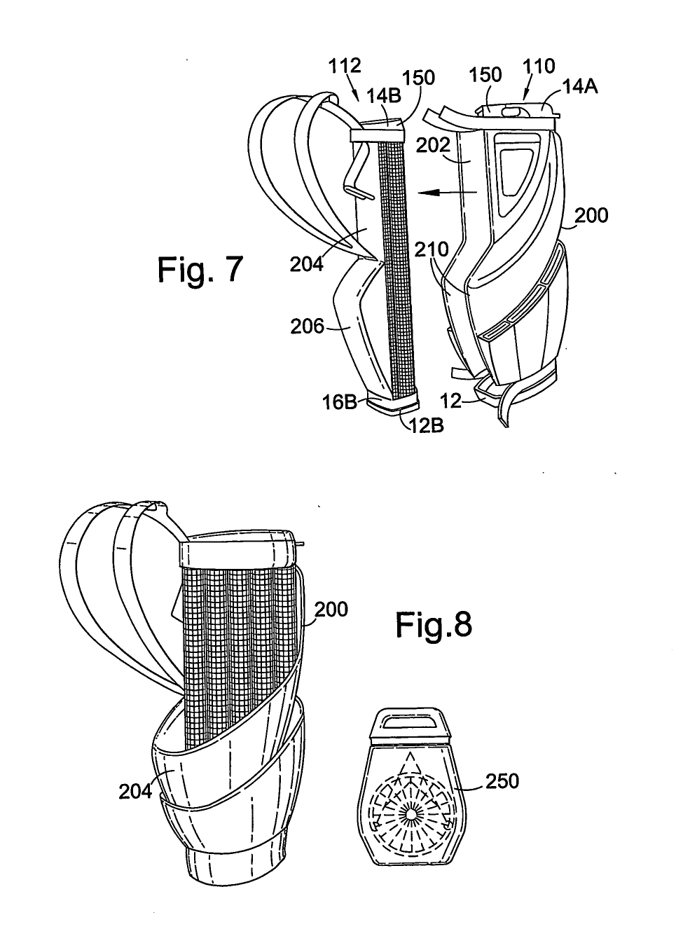

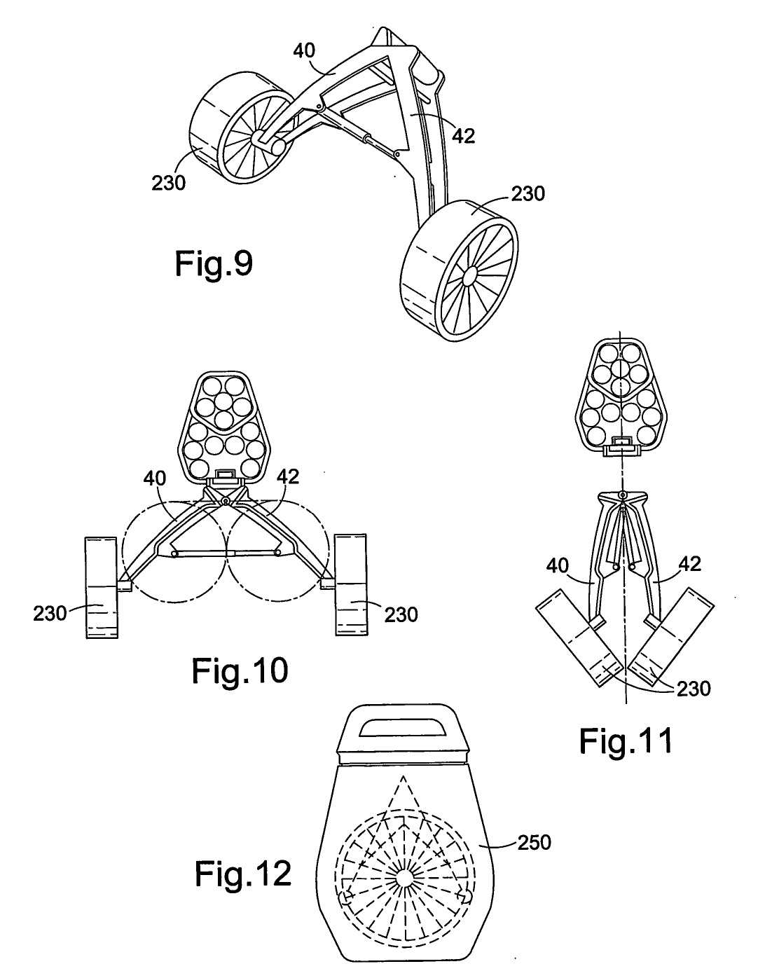

Approximately half way along the spine 20 is attached a fitment 30 to which the undercarriage 32 can be clamped. The undercarriage 32 is of a generally A-frame construction where the cross bar of the “A” is made from a hinged strut 34 which is pivoted to the arms 40 and 42 of the A-frame at pivots 36 and 38. The hinged strut 34 has a hinge 36 at an intermediate portion thereof so that the strut 34 can be collapsed as is illustrated in FIG. 7.

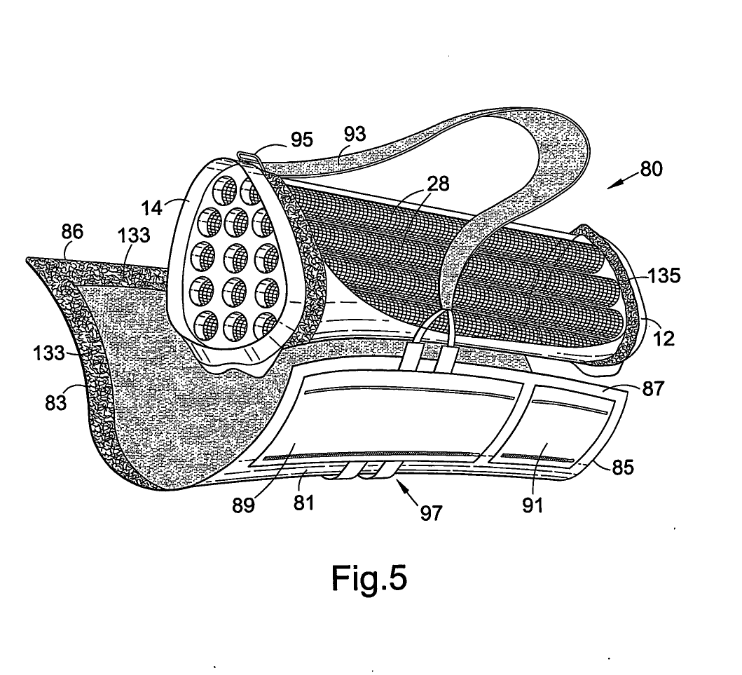

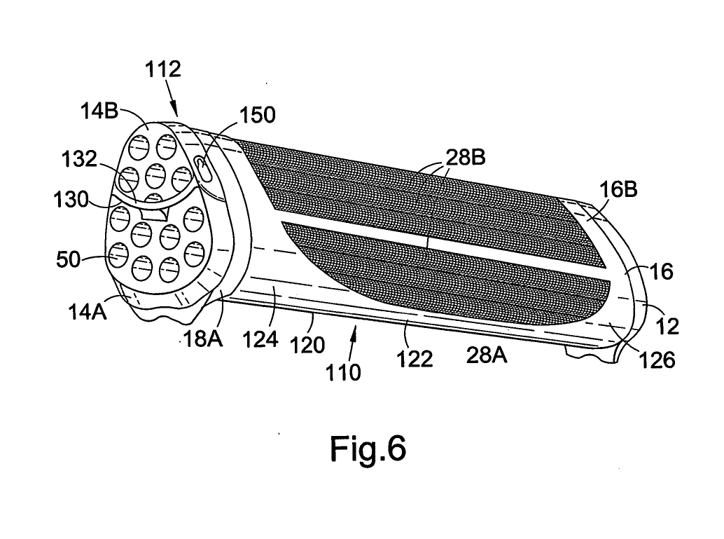

The arms 40 and 42 are pivoted at a common pivot 44 in such a manner that the spacing of the distal ends of the arms 40 and 42 away from each other will cause the proximal ends 46 and 48 to engage the fitment 30 thus securing the undercarriage 32 to the bag 10. It will be noted from FIGS. 5 and 6 that at the proximal ends 46 and 48 is formed rectangular cup like formation into which can be received the sides of the fitment 30 to partially envelop or pincer fitment thereby clamping the undercarriage 32 to the bag 10.

The bag 10 will receive a cover, similar to the cover 81 as illustrated in FIG. 5. The cover 81 of FIG. 5 can positioned onto the bag 10 of FIG. 1 by means of VELCRO along its top edge 83 and bottom edge 85, to mating VELCRO positioned around skirts 18 and 16 of the top 14 and base 12 respectively

Illustrated in FIGS. 2 to 5 is a bag 80, which is similar in constructions to that of FIG. 1. The bag 80 has like parts to the bag 10 and like parts have been like numbered. The golf bag 80 differs from the bag 10 by the top 14 is formed integrally with a frame 120. The frame 120 is formed from a rigid spine 122 along a first side (which is the base when the bag 80 is in a horizontal orientation) and a strut 123 along a second side which is opposite to the location of the first side.

The top 14 has an array of 14 apertures 50 each having their cylindrical spigot 51 extending towards the base end 125. As can be seen in FIG. 2, the base end 125 is formed from an integrally formed ring which will receive the base 12. This arrangement allows the 14 tubes 28 to be inserted into, or mounted on the spigots 51, then the free ends adjacent the ring of the base end 125 are aligned with the spigots 49 on the base 12, as the base 12 is positioned into and secured to the ring of the base end 125. The base 12 can be secured by sonic welding or any appropriate method.

As mentioned above the tubular members 28 illustrated in FIGS. 3 and 4 have a series of apertures 53 which are hexagonal in shape, which provides a balance between minimising the amount of material in the tube 28 and an optimising the strength properties of the tube 28. The size of the apertures 53 is such that the internal surface of the tube 28 will be sufficiently smooth that a club handle will not be retarded in its movement into the tube 28 or otherwise snagged, if the handle makes contact with the inside of the tube 28.

By providing the apertures 53, the lateral strength or lateral rigidity of the tubes 28 is decreased to the point where the tubes maintain their ability to locate and hold clubs, but are able to be compressed laterally. This assists to give the bag 80 a soft feel when being carried.

The frame 120 also includes a web portion 124 adjacent top 14 and web portion 126 adjacent base 12 which extend circumferentially away from the spine 122 and around to form the skirt 18A on top 14 and skirt 16A on the ring of the base end 125. The webs 124 and 126 follow the contours of the tops 14 and base 12.

The cover 81, which is illustrated in FIG. 5, has along its top edge 83, bottom edge 85 and side edges 86 and 87, a strip of hook material 133. The frame 120 has loop material 135 on the skirts 18A and 16A of the top 14 and base end 125 respectively. The spine 122 also has a double width strip of loop material (to receive the two strips of hook material along sides 86 and 87), which is positioned between the top 14 and base end 125. The hook and loop material can be of the type sold under the trade mark VELCO. The hook and loop material can be replaced by other means to join a material cover to a frame, such as press studs, buttons, hooks and eyelets, or zippers.

The cover 81 can include zippered pockets 89 and 91, such as is generally expected of a conventional staff bag as used by golfers. As can be seen from FIG. 5 the strap 93 is secured to the top 14 of bag 80 at a static anchorage 95. The mid point fixing 97 for the shoulder strap 93 is on the outside of the cover 81 and is attached thereto by stitching it to a woven nylon belt which is stitched across the full width of the cover 81.

Illustrated in FIG. 6 is a bag 100 similar in construction to that of FIGS. 2 to 5. The bag 100 has like parts to that of the bag 80 and like parts have been like numbered.

The golf bag 100 is made up of two bag portions 110 and 112 which are held together to form the single composite bag 100. The main portion 110 and a par-3 portion 112.

At the lower end of the main bag portion 110 is a base 12 which is dish shaped like the previous embodiment and is of a unitary construction. The base 12 of bag 100 differs from the base 12 of bag 10 in that the portion of the base 12 which receives the base 12B of the par-3 portion 112 does not include 6 cylindrical spigots.

At the top of the main bag portion 110 is a top portion 14A with sufficient space for eight golf clubs and having eight apertures 50 therein. Extending between the base 12 and top 14A are eight mesh tubes 28A which are contained within an open tube like frame work 120. The tube like frame work 120 has a relatively rigid spine 122 which extends from the base 12 through to the top 14A and is secured thereto by adhesive, riveting or other appropriate means. The tube like frame work 120 also includes a web portion 124 adjacent top 14A and web portion 126 adjacent base 12 which extend circumferentially away from the spine 122 and around the internal portions of the skirt 18A on top 14A and skirt 16 on base 12 and is secured thereto. The webs 124 and 126 follow the contour of the top 14A.

It will be noted that the top 14A has a concave portion 130 into which is received a convex portion 132 on the par-3 top portion 14B. The par-3 portion 112 has its own base member 12B which is illustrated in FIG. 3 which sits within the base 12. The par-3 bag portion 112 can nest into the main bag portion 110 at two locations. Those two locations are firstly at the base by the nesting of the base 12B within base 12, and secondly by the nesting of the convex and concave formations 132 and 130 of top portions 14B and 14A respectively. Additionally there is assistance in nesting provided by the longitudinal sides of respective adjacent tubes 28B and 28A.

The par-3 bag portion 112 has its own rigid spinal member 140 from which webs 142 and 144 extend circumferentially around the par-3 bag portion 112.

The main bag portion 110 and par-3 bag portion 112 can be secured together by means of the cover and its velcro fastenings along its top and bottom edges. To do this the cover is attached to the skirts 18A and 18B on tops 14A and 14B, the skirt 16 on base 12 and a skirt 16B on the base 12B as illustrated in FIG. 7.

If desired additional latching mechanisms 150 can be provided so that the tops 14A and 14B can be also latched together so that if required a cover need not be utilised to hold the bags together or both the cover and latches used in combination.

If desired the base 12 and base 12B can be complementarily shaped, in the same manner as tops 14A and 14B, with the base 12B being latched to the base 12, or held in position by the enveloping cover and its velcro edges. While it is envisioned that this will not provide as rigid a composite bag 100 as the construction previously described, it will be satisfactory for use as a composite golfbag.

As illustrated in FIG. 7 the main bag portion 110 and par-3 bag portion 112 are shown in a separated condition and in the left hand side of FIG. 8 the bag 100 is illustrated in an assembled condition.

The par-3 bag portion 112 in FIG. 7 is held together with the bag portion 110 by means of latches 150 with the cover 200 being relatively rigid and providing an opening 202 into which can be received the bag portion 112. As can be seen from FIG. 7 the bag portion 112 includes a portion with a cover 204 and its own smaller bag 206.

If the cover 200 is of a relatively rigid construction then no means is required to attach the free ends 210 of the cover 200 to the bag portion 112. However if a cover 200 is relatively flexible it would be desirable to secure the free ends 210 to the bag portion 112. This can be done by means of velcro around the periphery of the free ends 210 or by means of zippers or other attachment mechanism..

As illustrated in FIG. 12 the undercarriage 32 can be positioned inside a bag 250 by detaching the wheels 230 from the arms 40 and 42.

In another option, the axles of the wheels can be rotatably mounted on the distal ends of the arms 40 and 42, so that when in the unlocked condition, the axles can be rotated so that the wheels will rest in adjacent both arms 40 and 42 allowing the undercarriage 32 to be positioned in a bag, albeit of a different shape to the bag 250 illustrated in FIG. 12.

It will be understood that the invention disclosed and defined herein extends to all alternative combinations of two or more of the individual features mentioned or evident from the text. All of these different combinations constitute various alternative aspects of the invention.

The foregoing describes embodiments of the present invention and modifications, obvious to those skilled in the art can be made thereto, without departing from the scope of the present invention.

1. A golf bag having a closed base and a top with at least one aperture therethrough so as to receive at least one shaft of a golf club, said base and said top being interconnected by means of at least one tubular member which has its ends secured relative to said base and said top, characterised in that said at least one tubular member has a series of apertures through the side walls of said tube.

2. A golf bag according to claim 1, wherein at least one tubular member has a mesh construction.

3. A golf bag according to claim 1, wherein the shape of said apertures is selected from one of or a combination of one or more of the following: circular, square, rectangular, diamond shaped, rhombic, pentagonal, hexagonal, octagonal.

4. A golf bag according to claim 1, wherein said at least one tubular member is formed as a tube by a moulding process.

5. A golf bag according to claim 1, wherein said at least one tubular member is formed from an elongated piece of sheet material with the longitudinal sides of said sheet material being joined end to end.

6. A golf bag according to claim 1, wherein between said base and said top there is provided an appropriately rigid spine member.

7. A golf bag according to claim 1, wherein a web member extends from said spine portion in opposite directions around said golf bag.

8. A golf bag according to claim 1, wherein said web portion is located adjacent both said top and said base.

9. A golf bag according to claim 1, wherein a substantial proportion of the length of said at least one tubular member is not covered by a web portion.

10. A golf bag according to claim 6, wherein said spine member is hollow.

11. A golf bag according to claim 6, wherein said spine member receives a handle member which can move into and out of said rigid spine member.

12. A golf bag according to claim 1, wherein said top and said base are of substantially the same shape in plan view.

13. A golf bag according to claim 1, wherein said golf bag is a composite of a first and second portions portion.

14. A golf bag according to claim 13, wherein said first portion has a base and a top which is in part the same shape as said base.

15. A golf bag according to claim 13, wherein said second portion has a top and a base which are similar in plan view.

16. A golf bag according to claim 1, wherein said first portion has a base and a top which is in part the same shape as said base, said second portion has a top and base which are similar in plan view and wherein the base of said second portion fits into the base of said first portion, with said top of said second portion being of a shape which complements the shape of said top of said first portion to form a combined shape which is substantially the same as said base of said first portion.

17. A golf bag according to claim 1, wherein said golf bag is a composite of a first and a second portion and both said first and second portions have at least one tubular member having a series of lateral apertures therethrough.

18. A golf bag according to claim 1, wherein said golf bag has a removable cover.

19. A golf bag according to claim 1, wherein said golf bag is a composite of a first and a second portion and the first and second portion of said golf bag are held together by a removable cover.

20. A golf bag according to claim 1, wherein said golf bag is a composite of a first and a second portion and a latch mechanism holds said tops together.

21. A golf bag according to claim 1, wherein said golf bag is a composite of a first and a second portion and said first and second portions have complementary nesting surfaces wherein said second portion can be nested within said first portion.

22. A golf bag according to claim 21, wherein said nesting surfaces are provided along one side of each of said first and second portions along a substantial length thereof.

23. A golf bag according to claim 1, wherein said golf bag has a removable cover and said cover is made from a synthetic or natural cloth or material.

24. A golf bag according to claim 1, wherein said golf bag has a removable cover and said cover is flexible or at least in part rigid or at least in part flexible or rigid.

25. A golf bag according to claim 1, wherein said golf bag has a removable cover and the cover is secured to said bag via surfaces on said top and base members or adjacent thereto.

26. A golf bag according to claim 1, wherein said golf bag has a removable cover and said cover is secured by means of one or more of the following: hook and loop fixing members, spigots and eyelets, zippers, buttons, press studs.

27. A golf bag according to claim 1, wherein there is a plurality of tubular members and apertures through said top.

28. A golf bag according to claim 1, wherein said golf bag includes a fitment on a side thereof said fitment allowing an undercarriage to be clamped thereto, said undercarriage have two first class levers with a common fulcrum whereby said fitment is clamped by proximal ends of said levers when said distal ends are spaced from each other.

29. A golf bag according to claim 28, wherein the proximal ends of said levers have wheels rotatably mounted thereto.

30. A golf bag according to claim 28, wherein said levers are held in space relation to each other by a strut.

31. A golf bag according to claim 1, wherein said golf bag includes a fitment on a side thereof, said fitment allowing an undercarriage to be clamped thereto, said undercarriage has two first class levers with a common fulcrum whereby said fitment is clamped by proximal ends of said levers when said distal ends are spaced from each other, said levers are held in space relation to each other by a strut and said strut is an adjustable length or of a hinged construction.

32. A golf bag according to claim 31, wherein said undercarriage can be detached and collapsed by collapsing said strut.

33. A method of manufacturing a golf bag, the method comprising the steps of:
forming a frame having a first and a second end,
said first end having at least one aperture therethrough to receive a shaft of a golf club,
said second end being formed with a ring to receive a base,
passing at least one tube into said frame via said ring so that the at least one tube will provide a passage from a respective one of said at least one apertures to said ring,
joining a base to said ring to secure the free ends of said at least one tube.

34. A frame from which to construct a golf bag, said frame including a top end having at least one aperture therethrough to receive one or more shafts of a golf club to be held in said bag, a base ring held spaced apart from said top end by a spine which extends between said top end and said base end.

35. A frame according to claim 34, wherein said top end and said base ring are of the same peripheral shape.

36. A frame according to claim 34 wherein the base ring receives a base end cap to close said ring.

37. A frame according to claim 34, wherein the base ring receives a base end cap to close said ring and said base end cap can be secured to said ring by one of the following: the interaction of tongues and recesses on the base and ring; rivets; adhesive; sonic welding.

38. A frame according to claim 34, wherein near to said top end and said base ring a web or skirt extends from said spine around a substantial proportion of the periphery of said top end and said base ring.

39. A frame claim 38 according to claim 34, wherein near to said top end and said base ring a web or skirt extends from said spine around a substantial proportion of the periphery of said top end and said base ring and said web or skirt has a tapered or convergent shape whereby near to said spine said web or skirt is of a greater width or height by comparison to the a location opposite said spine.

40. A frame according to claim 34, wherein at a location opposite to said spine a strut is used to maintain the portions of said top end and said base ring which are opposite to the location of connection to said spine, in their spaced apart condition.

41. A frame according to claim 34, wherein said frame including said top end, spine and base ring are formed from a single integral moulding.

42. A frame according to claim 34, wherein at a location opposite to said spine a strut is used to maintain the portions of said top end and said base ring which are opposite to the location of connection to said spine in their spaced apart condition; said frame including said top end, spine and base ring are formed from a single integral moulding; said strut can also be formed in the single integral moulding.
